(19) United States
(12) Patent Application Publication
(10) Pub. No.: US 2016/0321413 A1
(43) Pub. Date: Nov. 3, 2016

(54) Systems and Methods for Determining Patient Adherence to Healthcare Treatment

(71) Applicant: IMS Health Incorporated, Danbury, CT (US)

(72) Inventor: Michael Cheyne, Conshohocken, PA (US)

(21) Appl. No.: 14/699,770

(22) Filed: Apr. 29, 2015

(51) Int. Cl. G06F 19/00; G06N 99/00; G06N 7/00

(52) U.S. Cl. CPC G06F 19/345; G06F 19/322; G06F 19/3456; G06N 7/005; G06N 99/005

(57) ABSTRACT

The disclosure generally describes computer-implemented methods, software, and systems for determining patient adherence to a prescribed therapy. One computer-implemented method includes accessing a series of total prescription measurements and a series of new-to-brand prescription measurements for a pharmaceutical product over a study period. A model is developed that predicts patient adherence to the pharmaceutical product by applying a computer-based training algorithm to the accessed series of total prescription measurements and the accessed series of new-to-brand prescription measurements. Based on the developed model, future values of patient adherence to a therapy including the pharmaceutical product are predicted. A report containing the predicted future values of patient adherence is generated and stored.

### BACKGROUND

Healthcare professionals and organizations (e.g., hospitals, insurers, pharmaceutical product manufacturers, pharmacies, etc.) rely on information regarding patient behavior when making both business- and care-related decisions. For example, healthcare professionals and organizations interested in a new pharmaceutical product often seek information regarding the performance of the new product. Though determining total revenue generated by sales of a new product and even projecting future revenue are fairly straightforward, revenue is only one dimension of performance and provides little insight into patients' purchasing behavior.

### SUMMARY

The present disclosure relates to computer-implemented methods, software, and systems for determining patient adherence to a prescribed therapy (e.g., consumption or use of a pharmaceutical product) without the need for an in-depth study. One computer-implemented method includes receiving, from one or more healthcare computer systems, anonymized patient prescription data for a pharmaceutical product, the anonymized patient prescription data being received over a study period of time. Based on the received anonymized patient prescription data, a series of total prescription measurements are calculated, each total prescription measurement indicating the total prescription volume for the pharmaceutical product over a portion of the study period of time. Based on the received anonymized patient prescription data, a series of new-to-brand prescription measurements are calculated, each new-to-brand prescription measurement indicating the number of prescriptions associated with a patient taking the pharmaceutical product for the first time over a portion of the study period of time. The series of total prescription measurements and the series of new-to-brand prescription measurements are accessed and a model that predicts patient adherence to the pharmaceutical product is developed by applying a computer-based training algorithm to the accessed series of total prescription measurements and the accessed series of new-to-brand prescription measurements. Based on the developed model, future values of patient adherence are predicted and a report containing the predicted future values of patient adherence is stored.

Other implementations of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by a data processing apparatus, cause the apparatus to perform the actions.

These and other embodiments may each optionally include one or more of the following features. For instance, the method may further include accessing one or more additional total prescription measurements and one or more additional new-to-brand prescription measurements, wherein the additional total prescription measurements and the one or more additional new-to-brand prescription measurements correspond to periods of time related to which the future values of patient adherence were predicted; and adjust, based on the one or more additional total prescription measurements and the one or more additional new-to-brand prescription measurements, the model that predicts patient adherence. Additionally or alternatively, the method may further include storing an additional report comparing the predicted future values of patient adherence and the one or more additional total prescription measurements and the one or more additional new-to-brand prescription measurements.

Additionally or alternatively, the developed model may comprise an equation of v(t)=v(t−1)×p2×p3^{t-2}, where v represents a predicted value of patient adherence output by the model for time t, p2 represents a probability a patient observed in t=1 month will fill a prescription in t=2 month, and p3 represents a rate of adjustment of p2 over time. Additionally or alternatively, applying a computer-based training algorithm to the accessed series of total prescription measurements and the accessed series of new-to-brand prescription measurements may comprise fitting a model using the accessed series of total prescription measurements and the accessed series of new-to-brand prescription measurements as a training set and based on at least one of least squares minimization, maximum likelihood, or Bayesian regression.

The subject matter described in this specification can be implemented in particular implementations so as to realize one or more of the following advantages. First, the adherence measures described herein may be calculated very quickly (e.g., within seconds) using available data. Second, the adherence measures described herein are not susceptible to biases, in contrast to look forward eligibility analysis. Third, the adherence measures described herein are comparable in accuracy to traditional adherence methods, but can be calculated faster and cheaper.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example system for determining patient adherence to a prescribed therapy.

FIG. 2 is a flow chart of an example process for determining patient adherence to a prescribed therapy.

FIG. 3 is an example of various data related to the example process shown in FIG. 2.

Like reference numbers and designations in the various drawings indicate like elements.

### DETAILED DESCRIPTION

This disclosure generally describes computer-implemented methods, software, and systems for determining patient adherence to a prescribed therapy. In one solution for determining patient adherence, a skilled analyst must extract a large set of healthcare claims/records from a database of longitudinal patient data, write and execute code that transforms that data into a sample that is believed to be longitudinally complete over some time period for a selection of patients, write and execute code that sorts those patients by certain attributes (e.g., when they were first observed filling a prescription for a pharmaceutical product, whether they were new to the product at time of first filling, etc.), and write and execute code that calculates at what rate these patients remain on therapy over some pre-determined period of time (i.e. a trial period). However, any solution relying primarily upon the expertise of an analyst to perform each study will necessarily be slow and costly.

Accordingly, there exists a need for a more automated process to determine patient adherence. The computer-implemented methods, software, and systems described herein utilize data available to a healthcare analytics organization and automated computer modeling techniques to provide a relatively quick prediction of patient adherence with accuracy comparable to that provided by an analyst. The measure of patient adherence produced by the disclosed process can be integrated into existing reports provided to healthcare professionals and organizations or can be displayed in a separate report.

For ease of explanation, various implementations described herein will be described with regard to a healthcare analytics system. However, these various implementations are not limited to the analytics of healthcare. Rather, the processes described herein for predicting adherence may be equally applicable to other products or services for which similar data regarding consumer purchases is available.

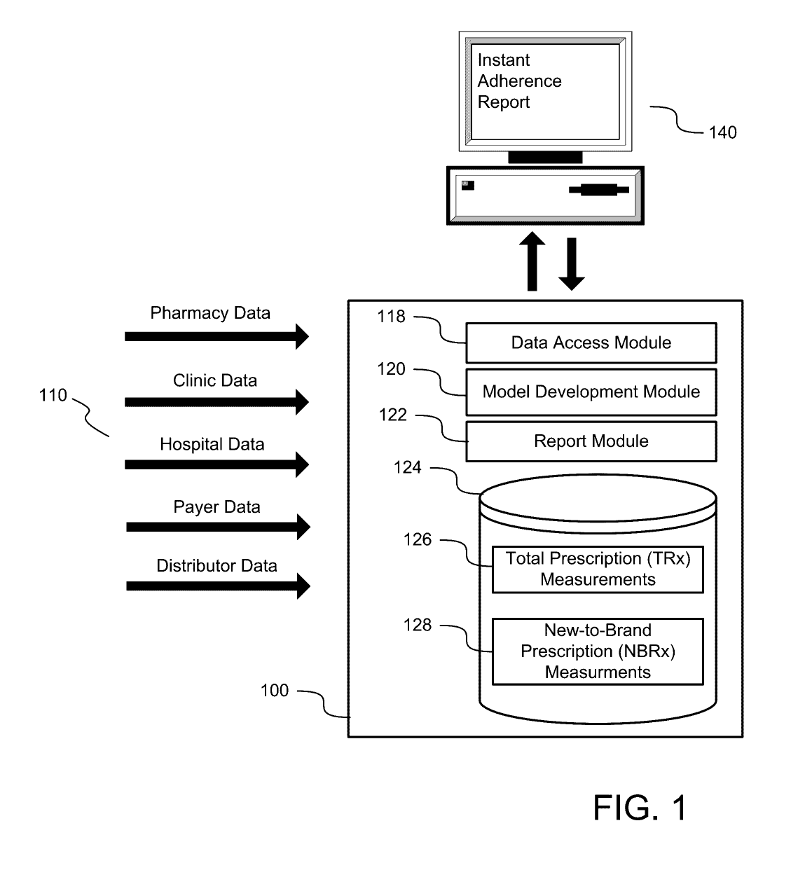

FIG. 1 illustrates an example healthcare analytics system 100 implemented in a computing system configured for determining patient adherence to a prescribed therapy. At a high-level, the illustrated example computing system 100 receives various data 110 about retail pharmaceutical outlets, patients, prescribers, and pharmaceutical distributors. The data 110 may include retail prescription data, encrypted patient data, and pharmaceutical purchase data.

The retail prescription portion of data 110 may include data regarding prescriptions dispensed in the retail sector. The retail prescription data may be received, for example, from one or more retail pharmaceutical outlets and represent data reflecting all pharmaceutical products dispensed by the one or more outlets, including information about the type of prescription used to obtain the product and the payment method used to purchase the product. The one or more retail pharmaceutical outlets, which may include pharmacy chains, independent pharmacies, long-term care facilities, and/or mail services, may provide the retail prescription data on a periodic basis (e.g., every day, week, or month). Moreover, the retail prescription data may be received from patients, prescribers, and pharmaceutical distributors. Additionally or alternatively, the retail prescription data may be collected by one or more other data collection systems and then provided to the healthcare analytics system 100.

The encrypted patient portion of data 110 may include anonymized retail patient-level data for the one or more patients. For example, the encrypted patient data may include information about retail pharmacy-sourced prescription insurance claims, retail pharmaceutical scripts, and/or patient profile data. The encrypted patient data may be received from one or more of the retail pharmaceutical outlets, patients, prescribers, and/or pharmaceutical distributors. For example, the encrypted patient data may be received from one or more prescribers/physicians with which a patient interacts, insurance companies to which a patient submits insurance claims, and/or retailers at which a patient purchases a pharmaceutical product. Additionally or alternatively, the encrypted patient data may be collected by one or more other data collection systems and then provided to the healthcare analytics system 100.

The pharmaceutical purchase data portion of data 110 may include information about pharmaceutical purchases made from distributors (e.g., pharmaceutical wholesalers or manufacturers) by one or more retail pharmaceutical outlets or other distributors. For example, the pharmaceutical purchase data may include information about the outlet from which a pharmaceutical product is purchased, the type of pharmaceutical product purchased, the location of both the purchaser and seller of the pharmaceutical product, when the purchase was conducted, and/or the amount of a pharmaceutical product that was purchased. The pharmaceutical purchase data may be received from one or more of the retail pharmaceutical outlets, patients, prescribers, and/or pharmaceutical distributors. For example, the distributors may provide the pharmaceutical purchase data regarding the pharmaceutical products the distributors have sold. Additionally or alternatively, the pharmaceutical purchase data may be collected by one or more other systems and then provided to the healthcare analytics system 100.

The retail prescription data, encrypted patient data, and pharmaceutical purchase data represent a nationwide, macro view of the sales of pharmaceutical products. For example, the retail prescription data, encrypted patient data, and pharmaceutical purchase data may be acquired/received by a third-party operator of the healthcare analytics system 100 from many different companies and/or entities within all levels the pharmaceutical product supply chain. Thus, the received retail prescription data, encrypted patient data, reference prescriber data, and pharmaceutical purchase data may represent a much wider breadth of information than the information to which any one company and/or actor within the pharmaceutical product supply chain would individually have access.

For illustrative purposes, healthcare analytics system 100 will be described as including a data access module 118, a model development module 120, a report module 122, and a storage device 124. However, the healthcare analytics system 100 may be any computing platform capable of performing the described functions. For example, the healthcare analytics system 100 may include one or more servers that may include hardware, software, or a combination of both for performing the described functions. Moreover, the data access module 118, the model development module 120, and the report module 122 may be embodied together or separately in hardware and/or software. Though the data access module 118, the model development module 120, and the report module 122 will be described as each carrying out certain functionality, the described functionality may be performed by one or more other modules in conjunction with or in place of the described module.

In some implementations, the healthcare analytics system 100 may be configured to receive and process the data 110, including the above-described retail prescription data, encrypted patient data, and pharmaceutical purchase data. In processing the received data 110, the healthcare analytics system 100 may filter or otherwise pre-condition the retail prescription data, encrypted patient data, and pharmaceutical purchase data for specific information. For example, the healthcare analytics system 100 may analyze the received retail prescription data, encrypted patient data, and pharmaceutical purchase data for to ensure that the data meets certain criteria (e.g., proper formatting, etc.).

After processing the received data 110, the healthcare analytics system 100 may be configured to aggregate the processed data into longitudinal encrypted patient data, prescriber data, outlet data, and/or prescription data. In some implementations, the healthcare analytics system 100 may create profiles for one or more patients, prescribers, and/or retail outlets with regard to which data is received. During aggregation, the healthcare analytics system 100 may be configured to calculate certain metrics regarding, for example, one or more patients, prescribers, healthcare entities, and/or pharmaceutical products. Two such metrics are total prescription (TRx) measurements 126 and new-to-brand prescription (NBRx) measurements 128.

A TRx measurement 126 indicates the total prescription volume for a pharmaceutical product over a specified period of time. In other words, a TRx measurement 126 is an estimate of the total number of prescriptions filled by or on behalf of a patient for a particular pharmaceutical product during a given reporting period. A TRx measurement 126 includes, for example, refill and renewal prescriptions for the pharmaceutical product, which are prescriptions patients get when they run out of refills. An NBRx measurement 128 indicates the number of prescriptions associated with a patient filling the pharmaceutical product for the first time over a portion of the study period of time. In other words, an NBRx measurement 128 in an estimate of the portion of the total number of prescriptions written by physicians for a particular pharmaceutical product that are being prescribed to the patient for the first time during a given reporting period.

The method by which the total prescription (TRx) measurements 126 and new-to-brand prescription (NBRx) measurements 128 are calculated is not a focus of this disclosure and any acceptable method may be used. In some implementations, the healthcare analytics system 100 may be configured to calculate past and estimate future values of TRx and NBRx for one or more pharmaceutical products based on the received data 110. In other implementations, the data processing module 118 may simply receive calculated past and estimated future values of TRx and NBRx for one or more pharmaceutical products from one or more other systems.

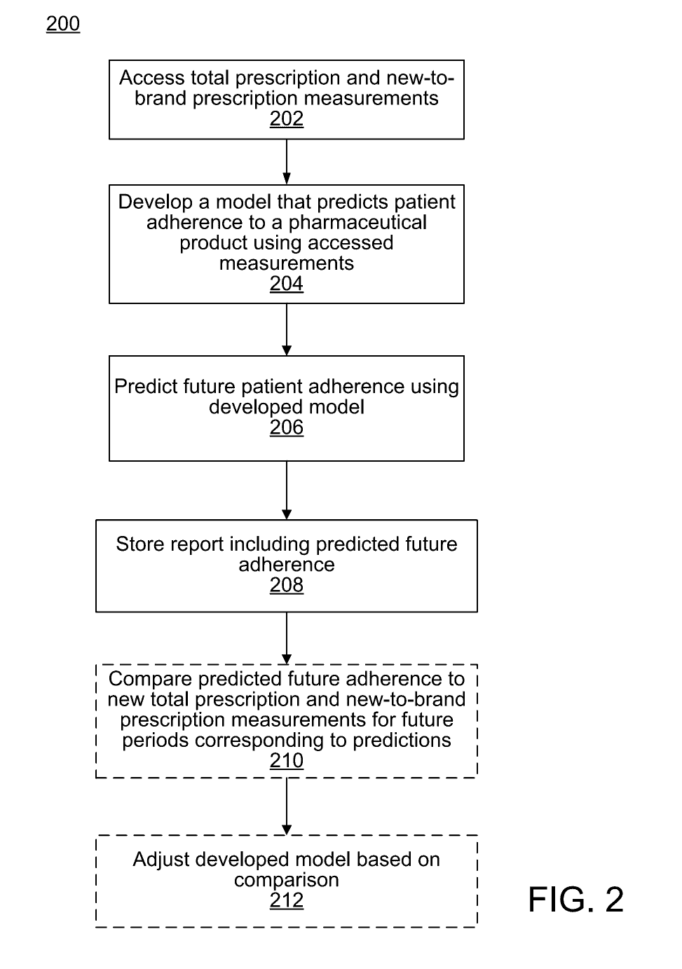

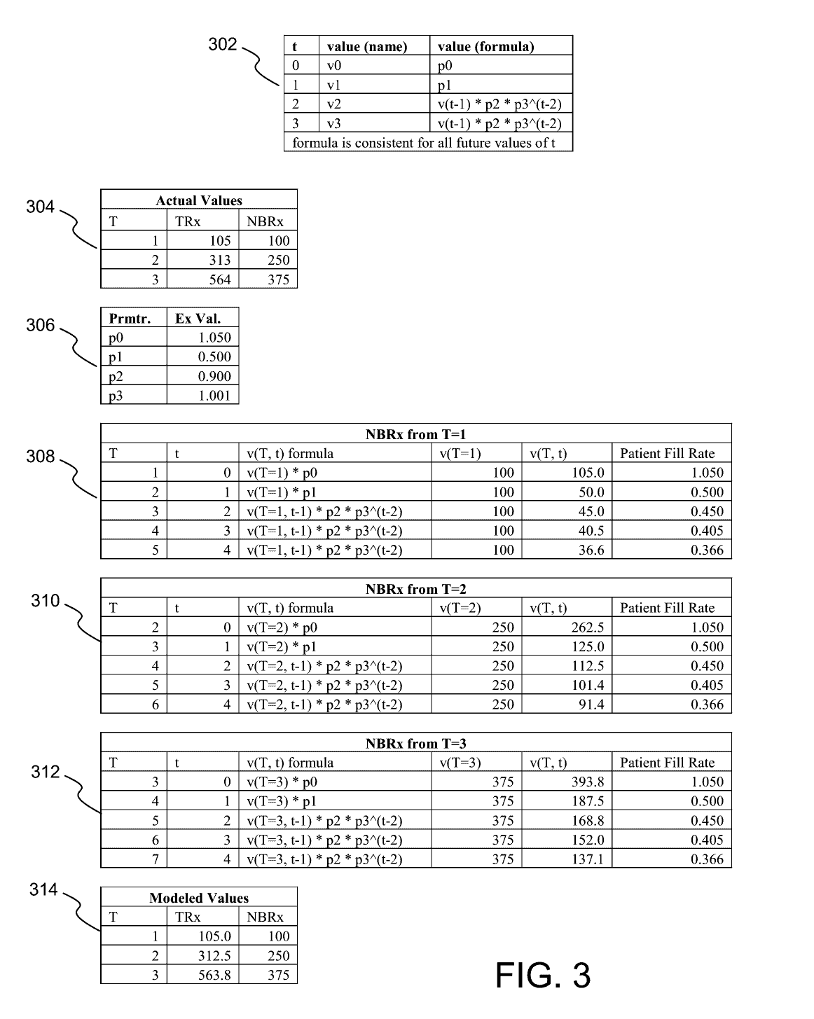

The model development module 120 utilizes the total prescription (TRx) measurements 126 and new-to-brand prescription (NBRx) measurements 128 calculated or received by the healthcare analytics system 100 to develop a model that predicts the adherence of patients to a prescribed therapy that includes one or more particular pharmaceutical products. One example of a process by which model development module 120 develops this adherence prediction model will be described with regard to FIGS. 2 and 3. Generally, the model development module 120 relies upon the direct connection between TRx measurements and NBRx measurement for a given pharmaceutical product to build a model solving for patient refilling patterns. Through various studies, estimates of NBRx have been found to closely approximate actual patient behavior, even though NBRx is an estimate. As will be described in greater detail below, since patients refilling or renewing over time produce the remaining value of TRx beyond patients that are new to a product, knowing both TRx and NBRx provides a basis for developing a model to estimate how many prescriptions over the long-term (i.e. adherence) each new patient (i.e., a single addition to the NBRx measurement) will ultimately request and fill.

As noted above, however, in some implementations the model development module 120 may be configured to model other types of adherence or to model adherence using different types of training data other than TRx and NBRx. For example, model development module 120 may be configured to calculate adherence by linking new patients (represented, for example, with NBRx) to other future activity (e.g. total pills, days of supply, etc.).

The report module 122 prepares reports based on the metrics and measures calculated by the healthcare analytics system 100, including, for example, the adherence measurements calculated by the model development module 120. The reports prepared by the report module 122 may include one or more of the metrics or measures calculated by the healthcare analytics system 100 as well as any other information contained in, inherent to, or calculated from the data 110. For example, a report generated by the report module 122 may include the measures of TRx and NBRx for one or more pharmaceutical products relevant to a healthcare professional or organization, as well as the estimated adherence measurements.

The reports generated by the report module 122 may be filtered based on any one or more criteria associated with a patient, prescriber, retail outlet, and/or pharmaceutical product. For example, the report module 122 may filter reports based on location, type of pharmaceutical product, medical specialty of a prescriber, category of a retail outlet (e.g., large chain retail outlet), and or one or more measures or metrics calculated by the healthcare analytics system 100. In other words, any data received and processed by the healthcare analytics system 100 or any measurements or metrics calculated by the healthcare analytics system 100 may be included in or used to filter the data included a report generated by report module 122.

Additionally, in some implementations, the reports generated by the report module 122 may be either dynamic or static. For example, the report module 122 may generate a report that includes data presented in one or more static formats (e.g., a chart, a graph, or a table) without providing any mechanism for altering the format and/or manipulating the data presented in the report. In some implementations, for example, the report module 122 may provide a static report in a PDF, spreadsheet, or XML format.

Additionally or alternatively, the report module 122 may generate a report that includes controls allowing a user to alter and/or manipulate the report itself. For example, the report module 122 may provide a dynamic report in the form of an HTML document that includes controls for filtering, manipulating, and/or ordering the data displayed in the report. Moreover, a dynamic report may include the capability of switching between numerous visual representations of the included in the dynamic report. In some implementations, a dynamic report may provide direct access to some or all of the above-described encrypted patient data, outlet data, and/or prescription data in an aggregated or un-aggregated form, prepared by the healthcare analytics system 100, as opposed to allowing access to only data, metrics, and/or measurement included in the report itself.

One or more clients 140 may interface with the healthcare analytics system 100 to request and receive reports created by the report module 122. In some implementations, for example, the one or more clients 140 may include a web browser that provides Internet-based access to the healthcare analytics system 100. Through the web browser, a user of a client 140 (e.g., a wholesaler, a retail outlet or corporate entity, or a prescriber) may request a static or dynamic report from the report module 122.

In some implementations, access to the healthcare analytics system 100 may be controlled in order to protect any confidential data stored in the healthcare analytics system 100. For example, in some implementation, each user of a client 140 that attempts to request a report from the healthcare analytics system 100 may be required to use a log in ID created by the owner/operator of the system 100 (e.g., IMS Health) and create a password to log into a user account. The user accounts may include identifying information about the user that may be used to limit the user's access to particular types of data, reports, and/or other functionality. For example, a user account associated with a prescriber may limit the prescriber to only viewing data for prescribers in his/her area and/or patient data for the patient's with which the prescriber has a professional relationship. Moreover, the user account associated with a prescriber may limit the level of detail of the data included in a report to prevent the prescriber from accessing another prescriber's private data.

There may be any number of clients 140 associated with, or external to, the example healthcare analytics system 100. For example, while the illustrated example healthcare analytics system 100 is shown in communication with one client 140, alternative implementations of the example healthcare analytics system 100 may communicate with any number of clients 140 suitable to the purposes of the example healthcare analytics system 100. Further, the term “client” and “user” may be used interchangeably as appropriate without departing from the scope of this disclosure. Moreover, while the client 140 is described in terms of being used by a single user, this disclosure contemplates that many users may use one computer, or that one user may use multiple computers.

The illustrated client 140 is intended to encompass any computing or communication device such as a desktop computer, laptop/notebook computer, wireless data port, smart phone, personal data assistant (PDA), tablet computing device, one or more processors within these devices, or any other suitable processing device available today or created in the future. For example, the client 140 may comprise a computer that includes an input device, such as a keypad, touch screen, or other device that can accept user information, and an output device that conveys information associated with the operation of the healthcare analytics system 100.

In some implementations, functionality described as being performed by the healthcare analytics system 100 may be performed by the client 140. For example, the healthcare analytics system 100 may provide a client 140 with direct access to the metrics and measurements calculated by the healthcare analytics system 100. As a result, some or all of the functionality described as being performed by the report module 122 may be performed by the client 140.

Turning now to FIG. 2, FIG. 2 illustrate a flow chart 200 for determining patient adherence to a prescribed therapy. For clarity of presentation, the description that follows generally describes method 200 in the context of FIG. 1. However, it will be understood that method 200 may be performed, for example, by any other suitable system, environment, software, and hardware, or a combination of systems, environments, software, and hardware as appropriate. For example, one or more of the data access module 118, the model development module 120, and the report module 122, the client 140, or other computing device (not illustrated) can be used to execute method 200 and obtain any data from the memory of the client 140, data access module 118, the model development module 120, and the report module 122, or the other computing device (not illustrated).

At 202, the data access module 118 accesses a series of total prescription (TRx) measurements 126 and new-to-brand prescription (NBRx) measurements 128 for a pharmaceutical product relative to a study period. The accessed total prescription (TRx) measurements 126 indicate the total prescription volume for the pharmaceutical product as aggregated at periodic or aperiodic intervals over the study period (e.g., an indication of the total number of prescriptions filled for the pharmaceutical product over the course of each week or month over the course of the study period). Similarly, the new-to-brand prescription (NBRx) measurements 128 are estimates of the portion of the total number of prescriptions filled by or on behalf of patients for a particular pharmaceutical product that are being prescribed to the patient for the first time at periodic or aperiodic intervals over the study period (e.g., an estimate of the number of new to brand prescriptions filled for the pharmaceutical product over the course of each week or month over the course of the study period). Each NBRx measurement 128 for the measured sub-interval of the study period is an integer in which each individual added element of the total NBRx integer represents a single patient that may or may not fill future prescriptions after their initial new prescription.

At 204, the model development module 120 utilizes the accessed series of total prescription (TRx) measurements 126 and new-to-brand prescription (NBRx) measurements 128 for a pharmaceutical product to develop a model that estimates patient adherence to therapies including the pharmaceutical product going forward. In general, the developed model mathematically links the series of TRx and NBRx using a set of assumptions. One example of an equation that serves as a mathematical basis for such a model, as well as an example of the development a model based on this example equation, is illustrated in FIG. 3. However, any similar equation the mathematically links the series of TRx and NBRx may be used to similar effect. In some implementations, the broad concept of the model that estimates patient adherence can be thought of as a weighted coin flip. To develop such a model, the healthcare analytics system 100 calculates the patient fill rate for the pharmaceutical product for the first month of the study period based on known TRx and NBRx values and then estimates the weights included in the model that cause the outputs of the model to match the available series of TRx and NBRx values.

For the sake of simplicity of explanation, the development of a model will now be described with regard to the equations illustrated in FIG. 3. In this example, each element of an NBRx measurement is assumed to represent a single patient that may or may not fill future prescriptions after their initial new prescription (i.e., the first time the patient is ever fills a prescription the pharmaceutical product as part of a medical therapy) and the period of each TRx and NBRx measurement represents a month within the study period. Other intervals of measurement are similarly applicable. Moreover, each patient is modeled to represent the same longitudinal value over any given time-aligned period. In other words, the values predicted by the model assume that each patient is representative of the average patient over any given analysis period, so the model illustrated in FIG. 3 predicts at as an average instead of at the individual patient level. In other implementations, a model may be developed that predicts behavior at a greater or lesser degree of granularity.

In the example illustrated in FIG. 3, the model development module 120 operates under an assumption that an average patient will fill future prescriptions beyond the first new prescription based on the principles shown in table 302, which studies have shown provide a reasonably high level of accuracy for estimates of patient adherence. According to the first principle assumed by the model development module 120, a certain percentage of new patients will fill another prescription in the month of their first new prescription (i.e. the month in which the patient is represented in the NBRx measurement). “T” is a representation of real-time from launch and “t” is a representation of the time for each “cohort” of initiating patients. That is, each month of NBRx has times starting at t=0 and so on, and each cohort's initial “T” represents the month of the study period when they initiated. The rate at which new patients will fill another prescription in the month of their first new prescription can be called “p0.” This principle is shown in the first row of table 302.

According to the second principle assumed by the model development module 120, a certain percentage of patients will fill a prescription in the month after their initial first new prescription (t=1). The rate at which this occurs can be called “p1.” P1 roughly represents the probability a patient will fill a prescription in the month after initiation (i.e., the measurement period immediately after the measurement period in which the patient is represented in the NBRx measurement). More specifically, P1 is the number of prescriptions filled per average patient per period t. In other words, if one patient fills two prescriptions in time t and another patient fills zero prescriptions in the same time t, the actual probability a patient fills in that time t would be 0.5, but the probability calculated by the model would be 1.0 for time t, because this implementation of the model operates on averages. This principle is shown in the second row of table 302.

According to the third principle assumed by the model development module 120, starting at the third month (t=2) of the study period, patients are assumed to fill prescriptions at some proportion of their fill rate in t=1 month. This rate can be called “p2”. P2 represents the probability a patient observed in t=1 month will fill a prescription in t=2 month. This principle is shown in the third row of table 302.

According to the fourth principle assumed by the model development module 120, starting at the fourth month (t=3) of the study period, the proportion “p2” can be adjusted up or down by some rate, which is referred to as “p3.” P3 is a modifier that allows for patients to increase or decrease their likelihood of filling a prescription over time, in excess of their “p2” base probability. This principle is shown in the fourth row of table 302.

Values for the assumed proportions p1, p2, and p3 are unknown prior to when the model development module 120 develops the model. The proportions p1, p2, and p3 are essentially variables within the formula that underlies the patient adherence model developed by the model development module 120. The model development module 120 constructs the mathematical model by solving for proportions p1, p2, and p3 such that the model development module 120 optimizes the formulas shown in table 302 based on the accessed series of total prescription (TRx) measurements 126 and new-to-brand prescription (NBRx) measurements 128. For example, in some implementations, the model development module 120 may be configured to minimize the square error between the modeled TRx value for time T and the actual TRx value for time T as represented in the accessed prescription (TRx) measurements 126.

An example result of this optimization process is shown in tables 304, 306, 308, 310, 312, and 314. In particular, the accessed series of total prescription (TRx) measurements 126 and new-to-brand prescription (NBRx) measurements 128 are shown in table 304. An estimate of the proportions p1, p2, and p3 is shown in FIG. 306. For each value of T from 1 to 3, tables 308, 310, and 312 illustrate the accessed NBRx measurements 128 for each month of launch (T) being converted to future TRx measurement by multiplying the NBRx value for time T by the patient value for each future time period (t). Table 314 shows the modeled values of total prescription (TRx) measurements when the accessed new-to-brand prescription (NBRx) measurements 128 are plugged into the formulas shown in table 302 with the proportion p1, p2, and p3 shown in table 306. The goal of the optimization process performed by the model development module 120 is to reduce the difference in the modeled TRx values shown in table 314 and the actual accessed TRx values shown in table 304. Once optimized values of proportions p1, p2, and p3 are estimated by the model development module 120, the resulting model may be used to estimate patient adherence.

As noted above, the model development module 120 may be configured to use any statistical method for estimating values of proportions p1, p2, and p3 in developing the patient adherence model. For example, the model development module 120 may be configured to use one or more of least squares minimization, maximum likelihood, or Bayesian regression. Notably, however, any method utilized by the model development module 120 for developing the patient adherence model will rely upon computer-based algorithms and processes. In order to effectively provide the above-described patient adherence analysis on a regular basis at a reasonable cost, the model development module 120 automatically develops the patient adherence model using computer-based algorithms and processes that permit relatively fast analysis (e.g., within few minutes or even a few seconds). In other words, the amount of data involved, complexity of the models and solutions, and speed with which results should be provided requires the model development module 120 operate using computer-based systems and processes.

Turning back to FIG. 2, at 206, the model development module 120 uses the developed patient adherence model to predict future patient adherence to therapies including the pharmaceutical product. Thus, in the example given in FIG. 3, the model development module 120 plugs the proportions p1, p2, and p3 and the accessed new-to-brand prescription (NBRx) measurements 128 into the equations shown in table 302 to predict patient adherence. The output of the model is an estimate of the portion of patients that will fill prescriptions for the pharmaceutical product at future intervals.

At 208, the report module 122 may generate and store one or more reports including the predicted patient adherence. These reports may be structured as described above with regard to FIG. 1. At 210, the model development module 120 may optionally be configured, at future intervals where new total prescription (TRx) measurements 126 and new-to-brand prescription (NBRx) measurements 128 become available to compare and evaluate the predicted patient adherence rates to the actual adherence rates reflected in the new total prescription (TRx) measurements 126 and new-to-brand prescription (NBRx) measurements 128. In this regard, the model development module 120 both develop measures of error for the previous patient adherence predictions. Additionally or alternatively, at 212, the the model development module 120 may be configured to refine the previously developed model using the new total prescription (TRx) measurements 126 and new-to-brand prescription (NBRx) measurements 128.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A system comprising:
a first set of one or more processors and a first set of one or more storage devices storing instructions that, when executed by the first set of one or more processors, cause the first set of one or more processors to perform operations comprising:
receiving, from one or more healthcare computer systems, anonymized patient prescription data for a pharmaceutical product, the anonymized patient prescription data being received over a study period of time;
based on the received anonymized patient prescription data, calculating a series of total prescription measurements, each total prescription measurement indicating the total prescription volume for the pharmaceutical product over a portion of the study period of time; and
based on the received anonymized patient prescription data, calculating a series of new-to-brand prescription measurements, each new-to-brand prescription measurement indicating the number of prescriptions associated with a patient taking the pharmaceutical product for the first time over a portion of the study period of time;
a second set of one or more processors and a second set of one or more storage devices storing instructions that, when executed by the second set of one or more processors, cause the second set of one or more processors to perform operations comprising:
accessing the series of total prescription measurements and the series of new-to-brand prescription measurements;
developing a model that predicts patient adherence to the pharmaceutical product by applying a computer-based training algorithm to the accessed series of total prescription measurements and the accessed series of new-to-brand prescription measurements;
predicting, based on the developed model, future values of patient adherence to a therapy including the pharmaceutical product are predicted; and
storing a report containing the predicted future values of patient adherence.

2. The system of claim 1, wherein the first set of one or more processors are the same as the second set of one or more processors and the first set of one or more storage devices are the same as the second set of one or more storage devices.

3. The system of claim 1, wherein the second set of one or more storage devices store instructions that, when executed by the second set of one or more processors, cause the second set of one or more processors to perform operations comprising:
accessing one or more additional total prescription measurements and one or more additional new-to-brand prescription measurements, wherein the additional total prescription measurements and the one or more additional new-to-brand prescription measurements correspond to periods of time related to which the future values of patient adherence were predicted; and
adjusting, based on the one or more additional total prescription measurements and the one or more additional new-to-brand prescription measurements, the model that predicts patient adherence.

4. The system of claim 3, wherein the second set of one or more storage devices store instructions that, when executed by the second set of one or more processors, cause the second set of one or more processors to perform operations comprising:
storing an additional report comparing the predicted future values of patient adherence and the one or more additional total prescription measurements and the one or more additional new-to-brand prescription measurements.

5. The system of claim 1, wherein the developed model comprises an equation of v(t)=v(t−1)×p2×p3^{t-2}, where v represents a predicted value of patient adherence output by the model for time t, p2 represents a probability a patient observed in t=1 month will fill a prescription in t=2 month, and p3 represents a rate of adjustment of p2 over time.

6. The system of claim 1, wherein applying a computer-based training algorithm to the accessed series of total prescription measurements and the accessed series of new-to-brand prescription measurements comprises fitting a model using the accessed series of total prescription measurements and the accessed series of new-to-brand prescription measurements as a training set and based on at least one of least squares minimization, maximum likelihood, or Bayesian regression.

7. A method comprising:
receiving, from one or more healthcare computer systems, anonymized patient prescription data for a pharmaceutical product, the anonymized patient prescription data being received over a study period of time;
based on the received anonymized patient prescription data, calculating, by one or more processors, a series of total prescription measurements, each total prescription measurement indicating the total prescription volume for the pharmaceutical product over a portion of the study period of time;
based on the received anonymized patient prescription data, calculating, by the one or more processors, a series of new-to-brand prescription measurements, each new-to-brand prescription measurement indicating the number of prescriptions associated with a patient taking the pharmaceutical product for the first time over a portion of the study period of time;
accessing, by the one or more processors, the series of total prescription measurements and the series of new-to-brand prescription measurements;
developing, by the one or more processors, a model that predicts patient adherence to the pharmaceutical product by applying a computer-based training algorithm to the accessed series of total prescription measurements and the accessed series of new-to-brand prescription measurements;
predicting, based on the developed model and by the one or more processors, future values of patient adherence to a therapy including the pharmaceutical product are predicted; and
storing, by the one or more processors, a report containing the predicted future values of patient adherence.

8. The method of claim 7, further comprising:
accessing, by the one or more processors, one or more additional total prescription measurements and one or more additional new-to-brand prescription measurements, wherein the additional total prescription measurements and the one or more additional new-to-brand prescription measurements correspond to periods of time related to which the future values of patient adherence were predicted; and
adjusting, by the one or more processors and based on the one or more additional total prescription measurements and the one or more additional new-to-brand prescription measurements, the model that predicts patient adherence.

9. The method of claim 8, further comprising:
storing, by the one or more processors, an additional report comparing the predicted future values of patient adherence and the one or more additional total prescription measurements and the one or more additional new-to-brand prescription measurements.

10. The method of claim 7, wherein the developed model comprises an equation of v(t)=v(t−1)×p2×p3^{t-2}, where v represents a predicted value of patient adherence output by the model for time t, p2 represents a probability a patient observed in t=1 month will fill a prescription in t=2 month, and p3 represents a rate of adjustment of p2 over time.

11. The method of claim 7, wherein applying a computer-based training algorithm to the accessed series of total prescription measurements and the accessed series of new-to-brand prescription measurements comprises fitting a model using the accessed series of total prescription measurements and the accessed series of new-to-brand prescription measurements as a training set and based on at least one of least squares minimization, maximum likelihood, or Bayesian regression.

12. A computer readable medium storing instructions that, when executed by one or more processors, cause the one or more processors to perform operations comprising:
receiving, from one or more healthcare computer systems, anonymized patient prescription data for a pharmaceutical product, the anonymized patient prescription data being received over a study period of time;
based on the received anonymized patient prescription data, calculating a series of total prescription measurements, each total prescription measurement indicating the total prescription volume for the pharmaceutical product over a portion of the study period of time;
based on the received anonymized patient prescription data, calculating a series of new-to-brand prescription measurements, each new-to-brand prescription measurement indicating the number of prescriptions associated with a patient taking the pharmaceutical product for the first time over a portion of the study period of time;
accessing the series of total prescription measurements and the series of new-to-brand prescription measurements;
developing a model that predicts patient adherence to the pharmaceutical product by applying a computer-based training algorithm to the accessed series of total prescription measurements and the accessed series of new-to-brand prescription measurements;
predicting, based on the developed model, future values of patient adherence to a therapy including the pharmaceutical product are predicted; and
storing a report containing the predicted future values of patient adherence.

13. The computer readable medium of claim 12, wherein the computer readable medium stores instructions that, when executed by the one or more processors, cause the one or more processors to perform operations comprising:
accessing one or more additional total prescription measurements and one or more additional new-to-brand prescription measurements, wherein the additional total prescription measurements and the one or more additional new-to-brand prescription measurements correspond to periods of time related to which the future values of patient adherence were predicted; and
adjusting, based on the one or more additional total prescription measurements and the one or more additional new-to-brand prescription measurements, the model that predicts patient adherence.

14. The computer readable medium of claim 13, wherein the computer readable medium stores instructions that, when executed by the one or more processors, cause the one or more processors to perform operations comprising:
storing an additional report comparing the predicted future values of patient adherence and the one or more additional total prescription measurements and the one or more additional new-to-brand prescription measurements.

15. The computer readable medium of claim 12, wherein the developed model comprises an equation of v(t)=v(t−1)×p2×p3^{t-2}, where v represents a predicted value of patient adherence output by the model for time t, p2 represents a probability a patient observed in t=1 month will fill a prescription in t=2 month, and p3 represents a rate of adjustment of p2 over time.

16. The computer readable medium of claim 12, wherein applying a computer-based training algorithm to the accessed series of total prescription measurements and the accessed series of new-to-brand prescription measurements comprises fitting a model using the accessed series of total prescription measurements and the accessed series of new-to-brand prescription measurements as a training set and based on at least one of least squares minimization, maximum likelihood, or Bayesian regression.
